(19) United States
(12) Patent Application Publication
(10) Pub. No.: US 2022/0325111 A1
(43) Pub. Date: Oct. 13, 2022

(54) METHOD OF PROVIDING A HYDROPHOBIC COATING USING NON-FUNCTIONALIZED NANOPARTICLES

(71) Applicant: Saudi Arabian Oil Company, Dhahran (SA)

(72) Inventors: Remi Mahfouz, Lyon (FR); Aziz Fihri, Paris (FR); Nada Qari, Dhahran (SA)

(21) Appl. No.: 17/809,748

(22) Filed: Jun. 29, 2022

Related U.S. Application Data
(62) Division of application No. 16/117,627, filed on Aug. 30, 2018.

(51) Int. Cl. C09D 5/08; C09D 7/40; C09D 5/16; C09D 7/61; C08K 3/36; C09D 163/04

(52) U.S. Cl. CPC C09D 5/08; C09D 7/68; C09D 5/1681; C09D 7/61; C08K 3/36; C09D 163/04; C08K 2201/005; F16L 58/1054

(57) ABSTRACT

An anti-corrosive coating for a substrate surface comprises an insulation layer positioned over the substrate and a cured epoxy layer positioned on the insulation layer, the cured epoxy layer including a plurality of nanoparticles having diameters within a range of about 200 nm to about 350 nm. Water droplets positioned on an external surface of the cured epoxy layer form a contact angle of at least 130 degrees.

### FIELD OF THE INVENTION

The present invention relates to corrosion-resistant coatings, and, more particularly, relates to a method of providing a hydrophobic coating using non-functionalized nanoparticles.

### BACKGROUND OF THE INVENTION

The diffusion of water through polymer coatings on infrastructure assets has been identified as the major contributor to asset corrosion damage. This damage leads to frequent coating replacement, which is associated with significant maintenance costs. Corrosion resistance can be increased, and related maintenance costs decreased, by the application of organic coatings to metal structures. Superhydrophobic coatings, having low surface energy and roughness, have been developed on which water forms nearly spherical droplets and can be easily shaken away. To date, hydrophobic coatings have been developed using several approaches including plasma deposition, sol-gel method, layer-by-layer assembly, chemical etching, chemical vapor deposition, and casting. Unfortunately, these methods have proven costly and time-consuming to produce and not practicable for large-scale structures.

Efforts have also been made to produce low cost superhydrophobic coatings based on cheaper materials such as zinc oxide (ZnO), titanium dioxide (TiO₂), cupric oxide (CuO) and silica (SiO₂). These efforts have focused on “functionalizing” the surface of pure particles with long carbon chains to increase their hydrophobicity. Functionalization is also time consuming and costly.

What is therefore needed is a cost-effective and efficient technique for providing anti-corrosive coatings, particularly for large structures.

### SUMMARY OF THE INVENTION

Embodiments of the present invention provide an anti-corrosive coating for a substrate surface. The coating comprises an insulation layer positioned over the substrate and a cured epoxy layer positioned on the insulation layer. The cured epoxy layer includes a plurality of nanoparticles having diameters within a range of about 200 nm to about 350 nm. Water droplets positioned on an external surface of the cured epoxy layer form a contact angle of at least 130 degrees.

In some embodiments, the plurality of nanoparticles is composed of silica. In other embodiments, the plurality of nanoparticles is composed of other materials or combinations thereof or with silica. The substrate on which the coating is used can be any structure subject to corrosion, such as the metallic surface of a pipe. The disclosed coating is highly hydrophobic; in some embodiments, water droplets positioned on an external surface of the cured epoxy layer form a contact angle of at least 134 degrees.

Embodiments of the present invention also provide a method of increasing the resistance of a structure covered with insulation to corrosion under insulation (CUI). The method comprises preparing a powder composed of nanoparticles having diameters in a range of about 200 nm to 350 nm, depositing a layer of epoxy material over the insulation on the structure, and embedding the powder of nanoparticles within the deposited epoxy material. Upon curing of the epoxy material, the nanoparticles become set in position within the layer of epoxy.

In some implementations, the powder of nanoparticles is prepared using the Stöber process. In certain embodiments, the plurality of nanoparticles is composed of silica. The disclosed method produces a highly hydrophobic coating; water droplets positioned on an external surface of the cured epoxy layer including the embedded nanoparticles form a contact angle of at least 130 degrees. In some embodiments, water droplets positioned on an external surface of the cured epoxy layer form a contact angle of at least 134 degrees.

These and other aspects, features, and advantages can be appreciated from the following description of certain embodiments of the invention and the accompanying drawing figures and claims.

### BRIEF DESCRIPTION OF THE DRAWINGS

FIG. 1 is a set of Fourier Transform Infrared Spectra (FT-IR) taken of silica nanoparticles of various diameters produced and procured for the tests disclosed herein.

FIGS. 2A through 2E are graphs of weight-loss percentage over temperature of different sized silica nanoparticles obtained by Thermogravimetric Analysis (TGA).

FIGS. 3A through 3C show Scanning Electron Microscope shows graphs of particle size distributions obtained for synthesized particles of targeted sizes of 140 nm, 200 nm and 430 nm, respectively.

FIGS. 4A through 4E are images of contact angle measurements of coatings using nanoparticles sizes of 25 nm, (FIG. 4A); 140 nm (FIG. 4B); 200 nm (FIG. 4C); 350 nm (FIG. 4D) and 430 nm (FIG. 4E), according to the present invention.

FIG. 5 is a graph showing the variation of contact angle measurement with nanoparticle size for coatings formed according to the present invention.

FIG. 6 is a schematic cross-section of a substrate covered with a coating prepared according to an embodiment of the present invention.

### DETAILED DESCRIPTION CERTAIN OF EMBODIMENTS OF THE INVENTION

A method of producing hydrophobic, anti-corrosive coatings is disclosed herein. Hydrophobicity is increased by adding non-functionalized silica nanoparticles having diameters in a range of about 200 nm to about 350 nm to the coating surface. The method is highly applicable to installed infrastructure, as it does not require the modifications of the already existing coatings.

Silica nanoparticles of various sizes were tested for hydrophobicity. During testing, silica nanoparticles were prepared using the Stöber synthesis method. The Stöber synthesis method is a chemical process used to prepare silica (SiO₂) particles of controllable and uniform size. The process is initialized by reacting a molecular precursor with water in an alcoholic solution. The products of the process aggregate and grow in size depending on the duration of the process. The Stöber process can produce silica particles with relatively uniform diameters within in a range of 50 to 2000 nm, depending on pH, timing and other conditions.

In some embodiments of the present invention, the Stöber process reaction is initiated by stirring tetraethyl ortho-silicate (Si(OC₂H₅)₄) with ethanol, deionized water and ammonium hydroxide for a specified duration. Silica nanoparticles of different (uniform) sizes were generated using this process. In particular, generally spherical particles of 140 nm, 200 nm, 350 nm and 430 nm diameter were generated for testing. In addition, 25 nm particles, produced by a different process, were procured. The silica nanoparticles were then heated in air (calcined) at 550° C. for 4 hours to remove all organic residue or functional groups on the surfaces of the nanoparticles.

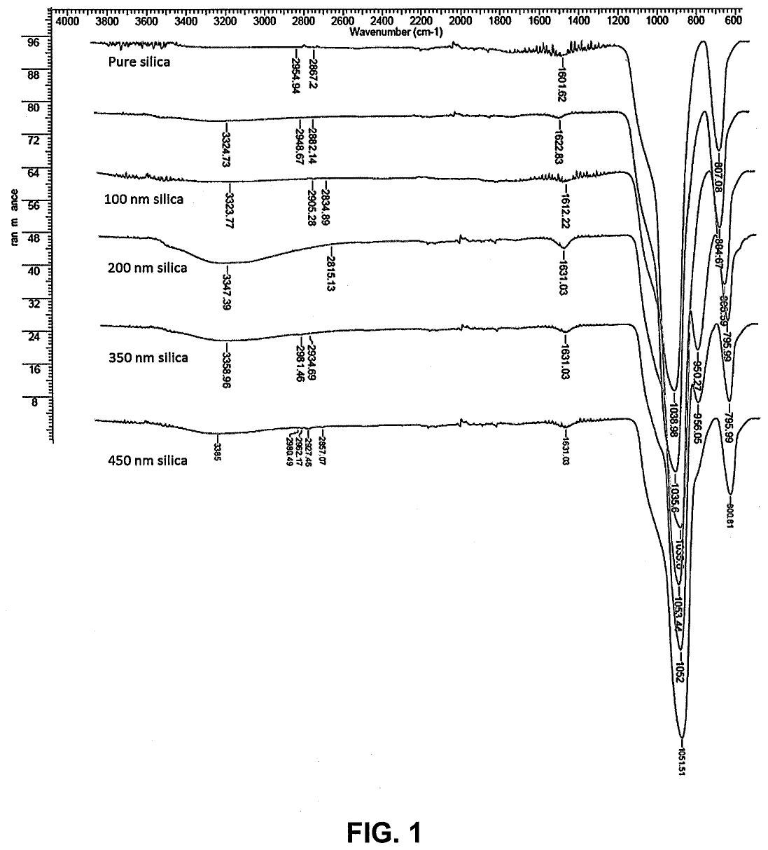

After calcining the silica nanoparticles, tests, including Thermogravimetric Analysis (TGA) and Fourier Transform Infrared Spectroscopy (FT-IR), were performed to determine the purity of the nanoparticle surfaces. FIG. 1 is a set of FT-IR spectra of the groups of nanoparticles produced and procured (25 nm) as well as a baseline spectrum of pure silica. The spectra show chemical similarities of composition, taking into account that an OH peak appearing in the 3000 nm⁻¹ region of the spectra mainly due to humidity and water absorption.

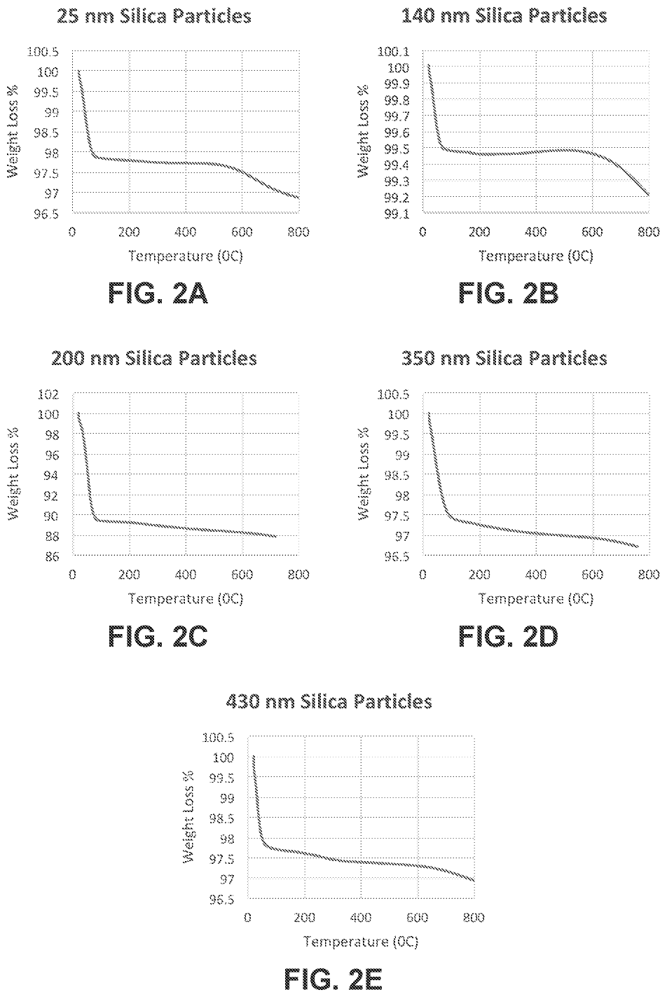

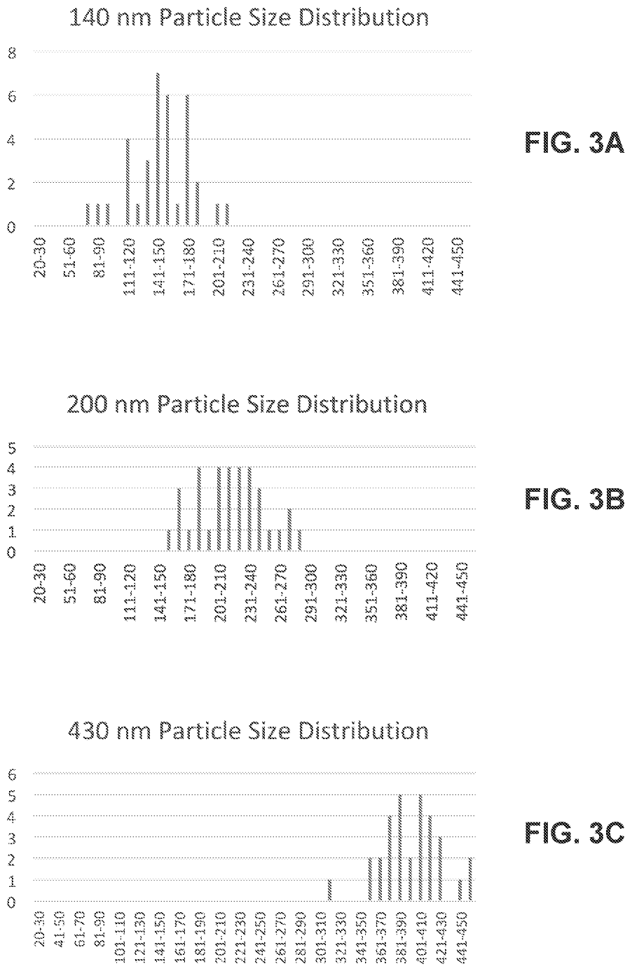

FIGS. 2A through 2E show graphs of weight-loss percentage over temperature for respective nanoparticle sizes of 25 nm, 140 nm, 200 nm, 350 nm, 430 nm, obtained using Thermogravimetric analysis (TGA). The graphs in all of FIGS. 2A through 2E exhibit a flat region up to 600° C., and for the larger particles, the graphs remain approximately flat up to 800° C. The flatness of the graphs provides evidence of the purity of the silica nanoparticles (i.e., that the silica nanoparticles do not have residual functional groups on their surfaces). The size and chemical composition of the synthesized silica particles obtained by synthesis were confirmed via scanning electron microscope (SEM) analysis shown in FIGS. 3A-3C. FIG. 3A shows the distribution of nanoparticle sizes centered around the targeted 140 nm diameter size; FIG. 3B shows the distribution of nanoparticle sizes centered around the targeted 200 nm diameter size; and 3C shows the distribution of nanoparticle sizes centered around the targeted 430 diameter size.

To produce the anti-corrosive corrosive coating on an asset, such as a steel pipe, an epoxy-based pre-coating is first applied on the outer surface of the asset. The epoxy pre-coating can be applied to the asset surface by hand brushing, for example. The synthesized silicon nanoparticles are then gathered to form a powder which is then dispersed onto the epoxy pre-coating using a sieve to set a maximum aggregated particle size. In some implementations a 450 μm sieve can be used. For the purpose of testing, powders containing specific particle sizes of 140 nm, 200 nm, 350 nm and 430 nm were produced. The coating, comprised of the epoxy and dispersed silica nanoparticles is then cured to harden. While different temperatures and durations can be used for curing, in some implementations, coatings can be cured at room temperature over a period of days (e.g., 2 days).

The prepared nanoparticle samples of various size bins were used to create anti-corrosive coatings. FIG. 6 is a schematic cross-section view of a coating system according to an embodiment the present invention. An asset (substrate) to be protected from corrosion, such as a metallic (e.g., stainless steel) pipe surface 605 forms a base. An insulation layer 610 is added over the substrate surface 605 as a first line of protection from moisture and temperature fluctuations. Exemplary materials from which the insulation can be fabricated include epoxy-based primer coatings providing cathodic protection. The insulation layer 610 is typically not adhesively bonded to the substrate surface 605. Therefore, small gaps 612 can form between the substrate surface and the insulation in which moisture can accumulate. In accordance with the present invention, an epoxy material layer 615 is deposited over the insulation layer 610. Commercial epoxy-based coatings such as isophoronediamine+diglycidyl ether of bisphenol A epoxy monomer, and bisphenol-A-epichlorohydrine epoxy monomer+triethylenetetramine can be used. As the epoxy is deposited, and before the epoxy sets, pulverized nanoparticles having a range of sizes between about 200 nm and 350 nm are added to the epoxy. Once the epoxy cures, the nanoparticles are embedded in the epoxy layer as shown schematically in FIG. 6.

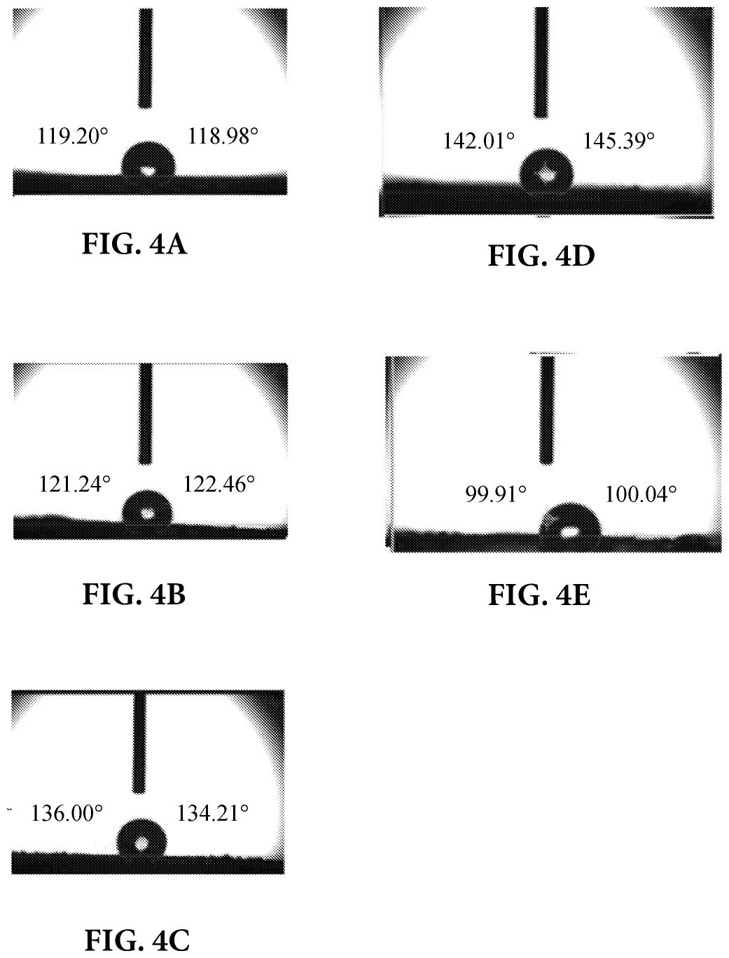

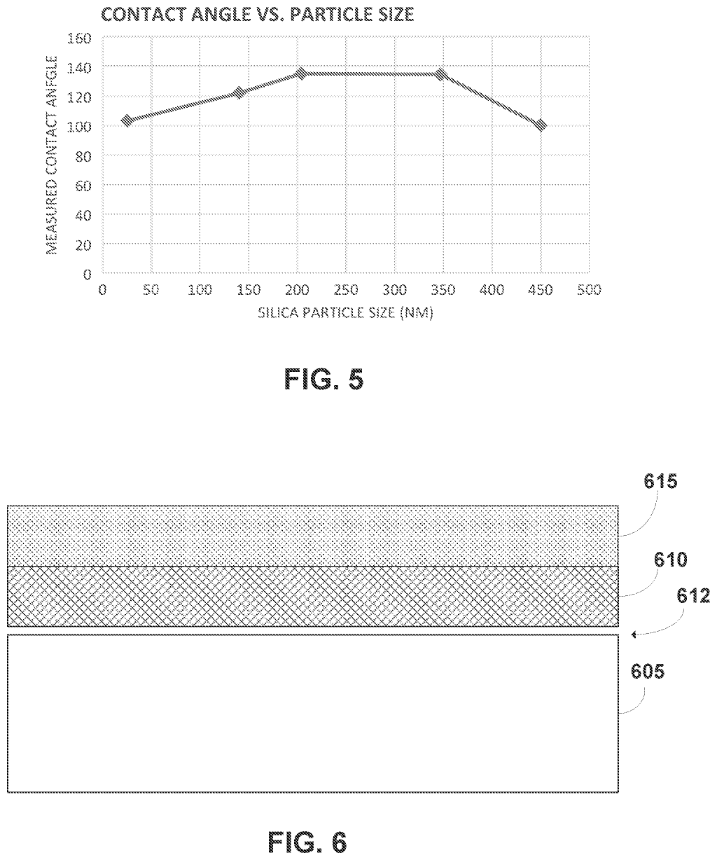

Exemplary coatings made according to this method were then tested for water contact angle (CA). The contact angle is that angle that water droplets form on the coating surface. The higher the contact angle, the greater the hydrophobicity of the surface, and the more resistant it will tend to be to water-based corrosion. Images of contact angle measurements on coatings using 25 nm, 140 nm, 200 nm, 350 nm, and 430 nm are shown in FIGS. 4A-4E, respectively. The collected data shows that the contact angle increases from 103° for 25 nm particles to 135° for 200 nm and remains approximately constant up to 350 nm. Surprisingly, at the larger 450 nm particle size, the contact angle decreases to about 100°. The tests demonstrate that the optimal particle size range for obtaining the highest contact angles is between about 200 nm and about 350 nm. A graph of contact angle versus average particle size is shown in FIG. 5, which shows the increase of the contact angle from 25 nm up to the optimal range of 200 to 350 nm, followed by a decrease in the contact angle at particle sizes higher than this range. The high contact angles provided by coatings having nanoparticles of the optimal size range are highly hydrophobic and can be replicated at scale on a wide variety of infrastructure surfaces.

While non-functionalized silica nanoparticles powders having particles with the 200 nm to 350 nm size range have been used to improve the hydrophobicity of epoxy coatings, non-functionalized, generally spherical nanoparticles of other materials can also be used, for example, metal oxides and other inorganic particles.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing, and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1-5. (canceled)

6. A method of increasing the resistance of a structure covered with insulation to corrosion under insulation (CUI), the method comprising:
preparing a powder composed of nanoparticles having diameters in a range of about 200 nm to 350 nm;
depositing a layer of epoxy material over the insulation on the structure; and
embedding the powder of nanoparticles within the deposited epoxy material;
wherein upon curing of the epoxy material, the nanoparticles become set in position within the layer of epoxy, and
wherein the nanoparticles lack functional groups on their surfaces (“non-functionalized”) which are of the type that can be purposefully added to the nanoparticles to alter the hydrophobicity of the cured epoxy layer.

7. The method of claim 6, wherein the powder of nanoparticles is prepared using the Stöber process.

8. The method of claim 6, wherein the plurality of nanoparticles is composed of silica.

9. The method of claim 6, wherein water droplets positioned on an external surface of the cured epoxy layer including the embedded nanoparticles form a contact angle of at least 130 degrees.

10. The method of claim 9, wherein water droplets positioned on an external surface of the cured epoxy layer form a contact angle of at least 134 degrees.

11. The method of claim 6, wherein the structure is a metallic pipe.

12. The method of claim 6, wherein the epoxy material comprises isophoronediamine and diglycidyl ether of bisphenol A epoxy monomer.

13. The method of claim 6, wherein the epoxy material comprises and bisphenol-A-epichlorohydrine epoxy monomer and triethylenetetramine.

14. The method of claim 6, wherein the powder of nanoparticles is added to the epoxy and before the epoxy sets.

15. The method of claim 8, further comprising the step of processing the silica nanoparticles before the embedding step to remove residual functional groups on their surfaces.

16. The method of claim 15, wherein the processing includes calcinating the silica nanoparticles to remove organic residue or functional groups on the surfaces of the silica nanoparticles.
